(19) United States
(12) Patent Application Publication
(10) Pub. No.: US 2004/0142675 A1
(43) Pub. Date: Jul. 22, 2004

(54) Multifunctional safety rear mirror for cars

(76) Inventor: Hao Jan Chen, Taipei (TW)

Correspondence Address: HAO JAN CHEN, P.O. BOX. 24-108, TAIPEI, TW

(21) Appl. No.: 10/348,227

(22) Filed: Jan. 22, 2003

(51) Int. Cl. H04B 1/06

(52) U.S. Cl. 455/344; 455/345; 455/347

(57) ABSTRACT

The present invention relates to a multifunctional safety rear mirror for cars, comprising an elastic clip disposed on one side of the rear mirror, a socket for externally connecting a power supply and a signal of a mobile phone earpiece, a hidden microphone, a speaker, and an automatic earpiece coiler installed at the back of the rear mirror, controlled by a control button, and indicated by an indicating light to connected to a circuit inside a casing in order to attain the effects of having a phone call without holding the phone and recording messages. The present invention may further comprises a reverse warning indicator, and a sensor at the back of the car, so that the multi-functional rear mirror can provide a line of vision while driving the car, and have the safety with simple and easy operations.

### BACKGROUND OF THE INVENTION

1. Field of the Invention

The present invention relates to a multifunctional safety rear mirror for cars, more particularly to a multifunctional safety rear mirror that focuses on the safety of using mobile phone in a car and provides a multiple of functions.

2. Description of the Related Art

Since the application of mobile phone is getting more popular day after day and the driving safety has to be taken into consideration, many countries have established laws to prohibit drivers to use mobile phones while they are driving. However, the general mobile phone earpiece connector has to be connected with the mobile phone socket, and the sockets of different branded mobile phones are usually not the same. Therefore, it is inconvenient for the manufacturer to make so many kinds of mobile phone sockets, and furthermore the plugging and unplugging after many times of use will cause damages to the socket. Moreover, users have to lower their head to press the buttons on the mobile phone to receive phone calls, but the buttons on the mobile phone are very small; that makes the operation and application very inconvenient and causes the drivers to leave their line of vision while they are driving. Thus, such arrangement has to be studied and improved.

The present invention discloses a multifunctional safety rear mirror that focuses on the safety of using a mobile phone in a car. The present invention comprises an elastic clip disposed on one side of the rear mirror, a socket for externally connecting a power supply and a signal of a mobile phone earpiece, a hidden microphone, a speaker, and an automatic earpiece coiler installed at the back of the rear mirror, controlled by a control button, and indicated by an indicating light to connected to a circuit inside a casing in order to attain the effects of having a phone call without holding the phone and recording messages. The present invention may further comprises a reverse warning indicator, and a sensor at the back of the car, so that the multi-functional rear mirror can provide a line of vision while driving the car, and have the safety with simple and easy operation.

In view of the above description about the shortcomings of the prior art, the present inventor based on years of experience accumulated from the engagement in the mobile phone earpiece industry conducted extensive research to resolve the aforementioned shortcomings and invented the multifunctional safety rear mirror for cars in accordance with the present invention.

### SUMMARY OF THE INVENTION

The primary objective of the present invention is to provide a safety rear mirror for cars, comprising an elastic clip disposed on one side of the rear mirror, a socket for externally connecting a power supply and a signal of a mobile phone earpiece, a hidden microphone, a speaker, and an automatic earpiece coiler installed at the back of the rear mirror, controlled by a control button, and indicated by an indicating light to connected to a circuit inside a casing in order to attain the effects of making, receiving, or recording a phone call without holding the phone. The present invention may further comprises a reverse warning indicator, and a sensor at the back of the car, so that the multi-functional rear mirror can provide users a safety vision while they are driving, and make its operation simple and easy for users.

The secondary objective of the present invention to provide a safety rear mirror for cars further comprising a reverse warning indicator for connecting to a sensor at the back of the car to remind the driver to pay attention to the object behind the car and watch the rear mirror in order to enhance the safety of driving.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a perspective diagram of a preferred embodiment of the present invention.

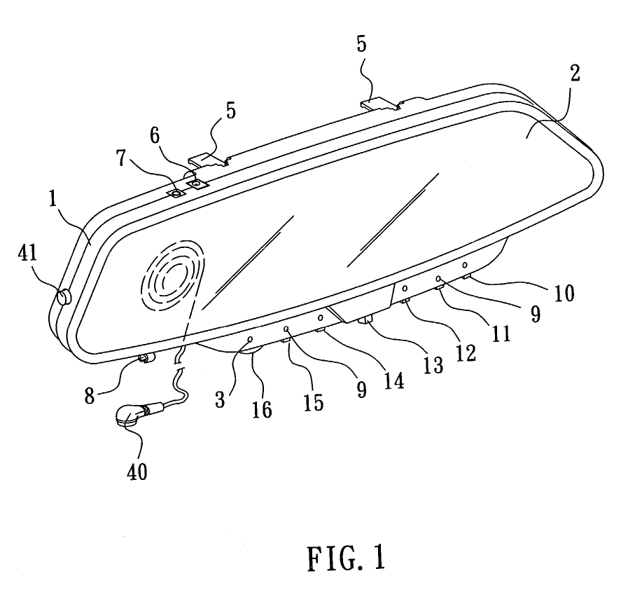

FIG. 2 is a rear-view diagram of a preferred embodiment of the present invention.

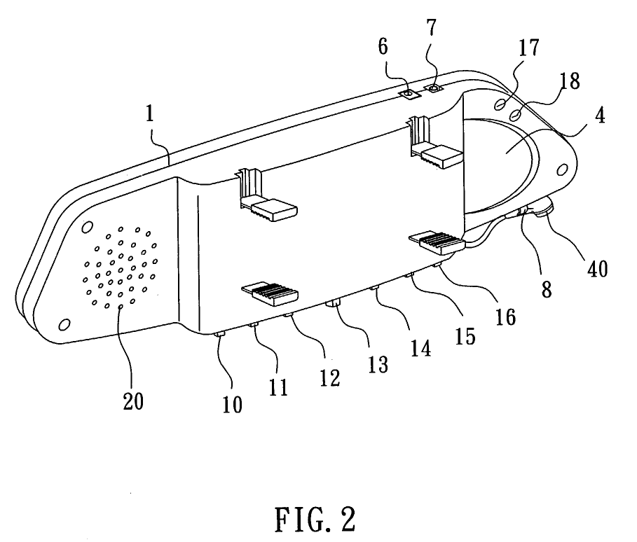

FIG. 3 is a perspective diagram of a preferred embodiment of the present invention.

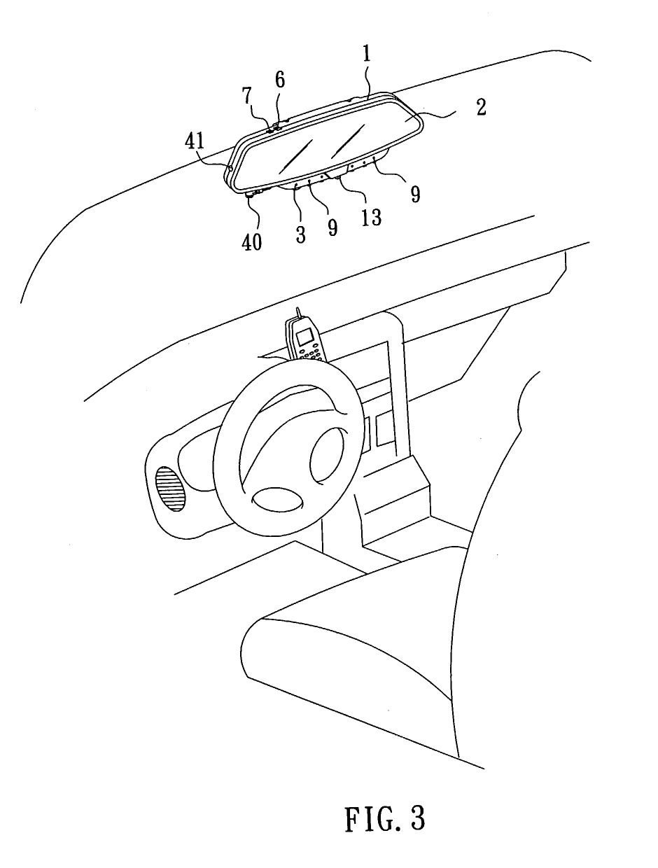

FIG. 4 is a perspective diagram illustrating the circuit connection in accordance with a preferred embodiment of the present invention.

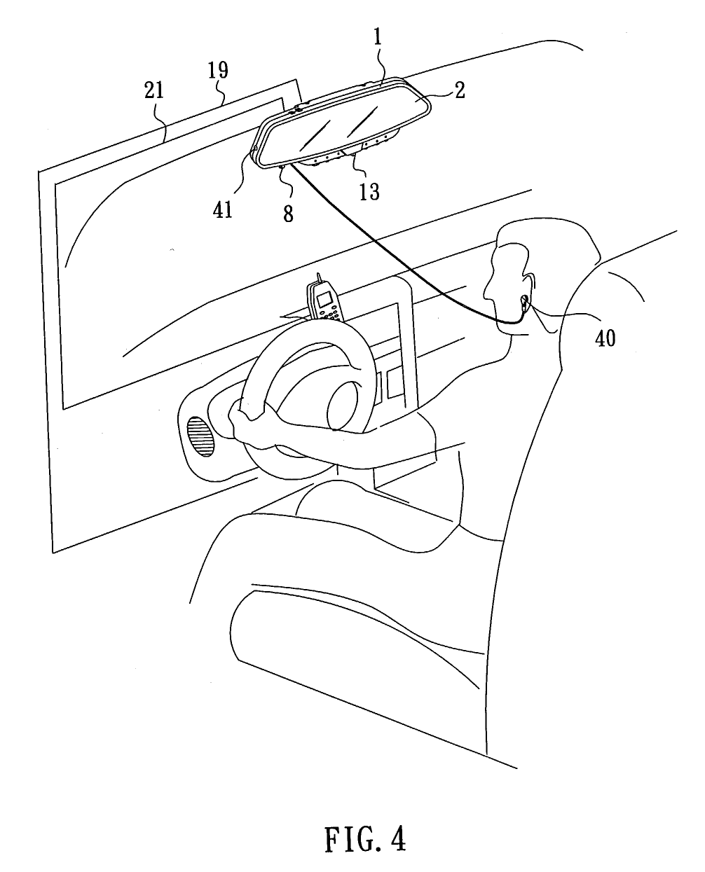

FIG. 5 is a perspective diagram of another preferred embodiment of the present invention.

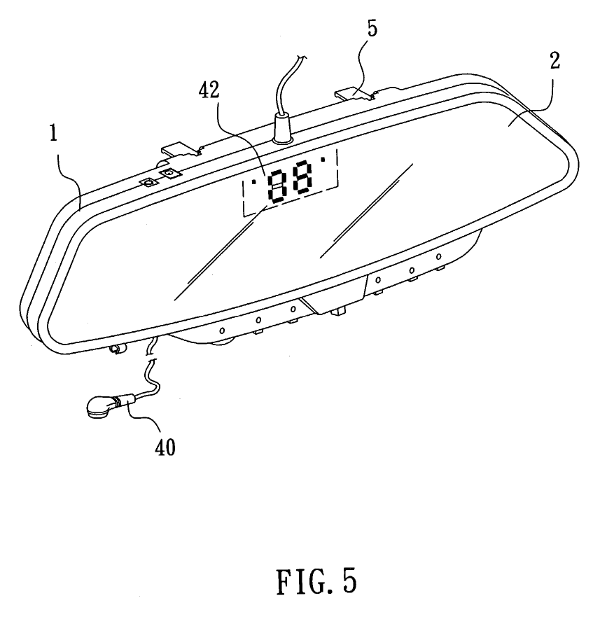

### DETAILED DESCRIPTION OF THE PREFERRED EMBODIMENTS

Please refer to the figures for the present invention having a main body 1, a rear mirror 2, a microphone 3, and an earpiece socket 4; wherein the main body 1 comprises an elastic clip 5 at the backside of the main body 1 for clipping the rear mirror 2 onto the car; a rear mirror embedded on the front side of the main body 1; an externally connected power supply socket 6 and a mobile phone signal socket 7 on the lateral side of the main body 1; a speaker 20 and an earpiece socket 4 at the back of the main body 1 such that a control button 41 can control an automatic coiling structure. A clipping base 8 may be installed if necessary to facilitate the collection of wire of the earpiece socket and fix the earpiece 40 into a position. A hidden microphone 3 can be installed under the front side of the main body 1, and a control button of an indicating light is disposed on the front side of the main body 1 for controlling the internal circuit to turn on/off or indicate the control buttons. For example, the control button 10 is a silent button, the control button 11 is the play button, the control button 12 is the recording button, the control button 13 is the earpiece On/Off button, the control button 14 is the receiver On/Off button, the control button 15 is the power On/Off button, and the control 16 is the volume button. If necessary, an echo fine tune button 17 and a microphone volume fine tune button 18 can be added.

In actual practice, the user may clip the elastic clip 5 at the backside of the main body 1 in accordance with the present invention onto the original rear mirror of the car, and install a power cable 19 and a signal line 21 along the edge of the windshield so that the cable and line will not affect the vision or the artistic look. The power cable 19 is connected to the externally connected power supply socket 6 and the power cable of the car, and the control button 14 can be used to turn on/off the received calls while driving the car. The control button 16 is used to adjust the volume of the speaker 20; the echo fine tune button 17 is used to adjust the volume of the echo, and the microphone fine tune button 18 is used to adjust the volume of the microphone 3. Furthermore, the control button 10 can be used to control the on/off of the microphone, so that the opposite party cannot hear the voice on your side for negotiation and discussion purposes. The control button 12 is used to record the conversation between both parties, and the control button 11 is used to play back the recording. For the privacy of telephone conversations, the user can pull the earpiece 40 from the earpiece socket 4 and plug the earpiece 40 into the user's ear, and then use the control button 13 to turn on the earpiece 40 for receiving calls, so that the passenger in the car is unable to hear the content of the telephone conversation. The entire operation can go with an indicating light 9 to indicate the ON/OFF status and the normal condition of the devices. Regardless of receiving phone calls or controlling operations, the user's view faces towards the windshield and thus can attain the effects of safe driving and simple and easy operation. Further, a reverse warning indicator 42 connected to a sensor at the back of the car can be added to detect any object behind the car and remind the driver to pay attention to the object and look at the rear mirror in order to enhance the safety.

The structure and device of the present invention have never been disclosed in the market and publication. In addition to its multifunctional features, the present invention allows users to receive phone calls while taking care of the line of vision for safety and the simple and easy operation. The present invention obviously improves the performance and fully complies with the patentability.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multifunctional safety rear mirror for cars, comprising an elastic clip disposed on one side of the rear mirror for clipping the rear mirror onto a rear mirror originally installed in the car, and a main body is disposed on a front side of the rear mirror; characterized in that a socket for externally connecting a power supply and a signal of a mobile phone earpiece being installed on the lateral side of the main body; a speaker and an automatic earpiece coiler being installed at the back of the main body and controlled by a control button to produce an automatic elastic coiling; a hidden microphone, a control adjusting button and an indicating light being installed under the front side of the main body.

2. The multifunctional safety rear mirror for cars of claim 1, wherein said main body under its front side further comprising a plurality of control buttons for controlling the silence, playback, and recording; and an indicating light.

3. The multifunctional safety rear mirror for cars of claim 1, wherein said main body at its backside further comprising an echo fine tune button and a microphone volume fine tune button.

4. The multifunctional safety rear mirror for cars of claim 1, wherein said main body further comprising a reverse warning indicator being connected to a sensor at the back of the car.
